(19) United States
(12) Patent Application Publication
(10) Pub. No.: US 2008/0178812 A1
(43) Pub. Date: Jul. 31, 2008

(54) PET BED AND METHOD FOR MAKING SAME

(75) Inventors: Edward P. Dennis, Conifer, CO (US); John D. Love, Nashville, TN (US)

Correspondence Address: MARSH, FISCHMANN & BREYFOGLE LLP, 3151 SOUTH VAUGHN WAY, SUITE 411, AURORA, CO, 80014, US

(73) Assignees: TOPET USA, INC., Morrison, CO (US); INTERNATIONAL TRADING COMPANY, LLC, Greenbrier, TN (US)

(21) Appl. No.: 12/023,898

(22) Filed: Jan. 31, 2008

Related U.S. Application Data
(60) Provisional application No. 60/887,487, filed on Jan. 31, 2007.

(51) Int. Cl. A01K 29/00; D01G 25/00

(52) U.S. Cl. 119/28.5; 19/296

(57) ABSTRACT

A pet bed such as a dog bed having a filler material that includes a fiber batt, the fiber batt having been formed by garnetting fibers to form a fiber web and cross-lapping the fiber web to form the fiber batt. The bed is advantageously resistant to wear and is resistant to the formation of depressions in the bed by the pet. A method for making the pet bed is also provided.

### CROSS-REFERENCE TO RELATED APPLICATIONS

This application claims priority to U.S. Provisional Patent Application Ser. No. 60/887,487 entitled “DOG BED AND METHOD FOR MAKING SAME”, filed Jan. 31, 2007, the disclosure of which is incorporated herein by reference in its entirety.

### BACKGROUND OF THE INVENTION

1. Field of the Invention

The present invention relates to a pet bed that includes a filler material made of garnetted fibers, such as garnetted polyester fibers, that have been cross-lapped to form a fiber batt. The present invention also relates to a method for making a pet bed.

2. Description of Related Art

Many dog owners purchase dog beds to provide their dogs with a place to sleep or lay. Dog beds typically include an outer covering defining an enclosed volume, where the enclosed volume is filled with a filler material to elevate the top surface of the bed from the ground and to provide comfort to the dog.

The filler material is typically a material that, in combination with the outer cover, is pleasant and comfortable for a dog to sleep or lay on. The filler material used for dog beds is typically in the form of loose material fragments, such as shavings, strands, loose fibers, including braided fibers, short fibers or a combination of such loose materials. The loose material can include, for example, wood shavings or loose polyester fibers. Typically, the loose material is blown into an enclosure and the enclosure is permanently sealed to prevent egress of the loose material. An outer cover can then be placed over the enclosure.

A disadvantage of loose filler materials is that pieces of the material tend to separate with prolonged use by the dog resulting in the bed having an uneven distribution of the filler material. For example, animals such as dogs often have a tendency to walk around their sleeping spot in a circular motion several times before laying down. This activity causes the loose filler material to separate and form depressions in the bed, making the bed uncomfortable for the dog to sleep on. The depression also increases wear on the bed. Such depressions can also form when the dog lies in the same position on the bed numerous times, causing matting of the bed due to the weight of the dog. Dogs will also tend to claw at their bedding in an attempt to remove the depression and “fluff up” the bedding, which also increases wear on the bed.

In addition, the use of loose filler materials can also result in a pet bed having a non-uniform thickness. In particular, the perimeter edges of the bed are typically less thick than the center portion of the bed, which can cause the bed to be uncomfortable for the pet to lie upon.

### SUMMARY OF THE INVENTION

One aspect of the present invention is directed to a pet bed. According to one embodiment, the pet bed includes an outer fabric cover having a top and bottom surface. A fiber batt is disposed within the outer cover, where the fiber batt has been formed by cross-lapping a garnetted web of fibers.

According to another aspect of the present invention, a method for the manufacture of a pet bed is provided. According to one embodiment, the method includes the steps of providing a garneted web of fibers comprising synthetic fibers, cross-lapping the fiber web to form a fiber batt, trimming the fiber batt to a predetermined size, and placing the fiber batt within an outer cover to form a pet bed.

These embodiments as well as additional embodiments of the present invention will be come apparent from the following description of the invention.

### BRIEF DESCRIPTION OF THE DRAWING

FIG. 1 illustrates a perspective view of a pet bed.

FIG. 2 illustrates a cross-sectional view of a pet bed.

### DESCRIPTION OF THE INVENTION

The present invention relates to a pet bed and a method for the manufacture of a pet bed. The pet bed can be used for domestic pet animals, and in particular for dogs. The pet bed can advantageously resist the formation of depressions in the bed, is more comfortable for the pet to lie upon and can have an extended useful life as compared to known pet beds.

In this regard, the pet bed can include a filler material that is highly resistant to the formation of depressions in the pet bed and that has a substantially uniform thickness. Accordingly, the pet bed includes garnetted and cross-lapped fibers in the form of a fiber batt. Garnetting (or carding) is a mechanical process whereby material fibers are combed and formed into a thin web of the fibers. The garneting process results in a preferential fiber orientation in the direction of the web axis.

Cross-lapping is a process wherein the thin fiber web from the garneting machine is layered from side to side onto a moving surface which runs perpendicular to the direction of the fiber web being fed to the cross-lapper. This results in a diagonally stratified fiber batt.

A cross-lapping operation and other textile operations are illustrated in U.S. Pat. No. 5,873,964 by Kwok which is incorporated herein by reference in its entirety. U.S. Pat. No. 3,558,029 by Manns, which is also incorporated herein in its entirety, illustrates a cross-lapping apparatus whereby the garneted webs are deposited in a crosswise fashion.

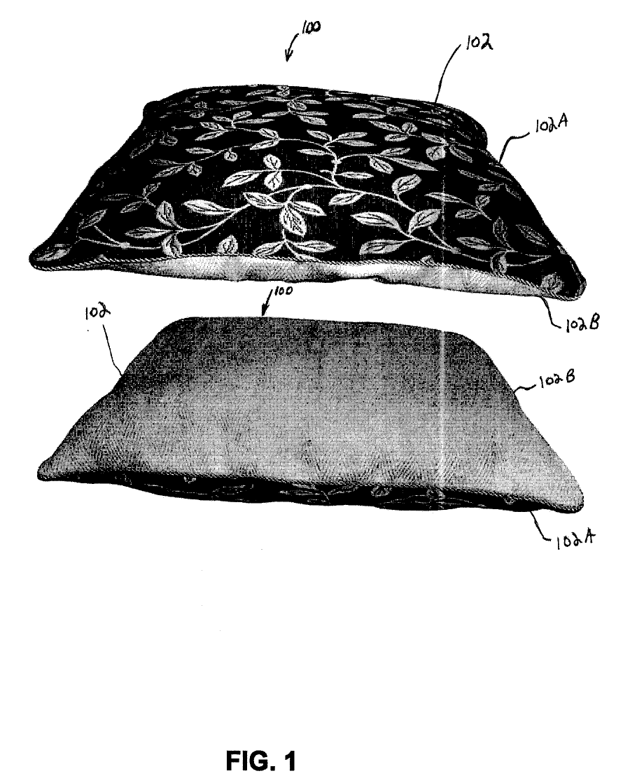

The present invention is particularly applicable to dog beds and FIG. 1 illustrates a perspective view of a dog bed. The top illustration shows a perspective view of a dog bed 100 and the bottom illustration shows a perspective view of the dog bed 100 turned 180° relative to the top illustration.

The dog bed 100 is suitably sized to accommodate a variety of dog breeds and is generally larger and thicker than, for example, a standard pillow for use by humans. The dog bed can have a variety of shapes such as a circular shape or a rectangular shape. Preferably the dog bed includes at least one major dimension (e.g., diameter or length along a side) that is at least 26 inches, more preferably for larger dogs at least 34 inches, more preferably for even larger dogs at least 42 inches, and more preferably for even larger dogs at least 52 inches. In one embodiment, the dog bed has a rectangular shape, such as the shape of a square.

The dog bed 100 includes an outer cover 102. The outer cover 102 can be made of cloth or a similar material that is sufficiently thick and durable to withstand clawing by the dog. As seen in FIG. 1, the cloth outer cover 102 includes two separate portions 102A and 102B that are sewn together to form the outer cover 102. In other embodiments, the outer cover 102 can be made of a single piece of fabric or more than two pieces of fabric.

At least a portion of the outer cover 102 is made of a material that is pleasant and comfortable for a dog to sleep or lay upon. The outer cover 102 can be sewn to permanently enclose the inner volume defined by the outer covering 102 from the surrounding environment. Alternatively, the inner volume defined by the outer cover 102 can include a zipper, hook and loop fastener, or other means to enable the outer cover to be removed and cleaned as needed. The outer cover may comprise any suitable material for constructing an outer covering of a dog bed. Nonlimiting examples include nylon, rayon, cotton, polyester, wool, other material for making cloth and any combinations thereof.

In one particular embodiment, the outer cover 102 includes an upper portion 102A and a bottom portion 102B that are fabricated from two different materials. For example, the bottom portion 102B can be fabricated from a durable material that is resistant to abrasion that can occur when the dog bed is placed on a hard surface, whereas the upper portion 102A can be fabricated from a softer material that is comfortable for the dog to lay upon.

The dog bed 100 also includes a filler material, which is not shown in FIG. 1. The filler material includes a garnetted fiber web in the form of a fiber batt, and preferably the fiber batt includes garnetted synthetic fiber, such as polyester fibers. Although the following description describes the use of polyester fibers, it will be appreciated that other types of fibers can be used as well, including natural fibers such as cotton.

Garnetting the polyester fiber forms the fiber into a garnetted web by interweaving the individual polyester fibers together in a way that greatly improves the weight carrying capacity of a given unit of polyester. After the fibers are processed through the garnett machine to form a web, the web of fibers is cross-lapped to form a fiber batt. Cross-lapping further increases the cross-orientation of the fibers, which enhances the structural integrity of the garnetted fibers. In one embodiment, the cross-lapping operation layers the garneted web at substantially right angles (i.e., crosswise) to enhance the durability of the dog bed.

The garneting process holds the fibers together and the cross-lapping process allows the dog bed to stay firm and maintain a uniform thickness for a longer period of time as compared to the industry standard practice of blowing individual loose fibers or other filler materials into the dog bed. This also allows the bed to resist matting (i.e., permanent compression) due to the weight of the animal on the bed.

Garneting and cross-lapping to form a fiber batt also makes the polyester extremely resistant to digging or clawing by the dog. This method reduces wear by resisting the animal's efforts to hollow out a space in the middle of the bed, which can shorten the useful life of the pet bed, while maintaining a soft and resilient surface for the animal to lie upon.

It is also preferred that cross-lapping enables the production of a final batt of fiber material that is approximately equal to required dimensions of the dog bed. This enables the placement of the fiber batt in a cover as a single, flat fiber batt, where the fiber webs comprising the batt all lie substantially parallel to the top and bottom surfaces of the bed. For example, cross-lapping can be used to form a fiber batt of approximate dimensions of 24 inches by 33 inches, which can be used to fill a pet bed having approximate total dimensions of 27 inches by 36 inches. This forms a pet bed having a more uniform appearance and having better performance (e.g., longevity) than a blown pet bed or a bed that incorporates rolled garnetted fiber webs to fill the bed. If necessary, the fiber batt can be trimmed (e.g., cut) to fit the desired size pet bed.

Further, the total thickness of the fiber batt in its natural (uncompressed) state is preferably at least about 3 inches and more preferably is at least about 4 inches to sufficiently elevate the body of the dog off of the ground.

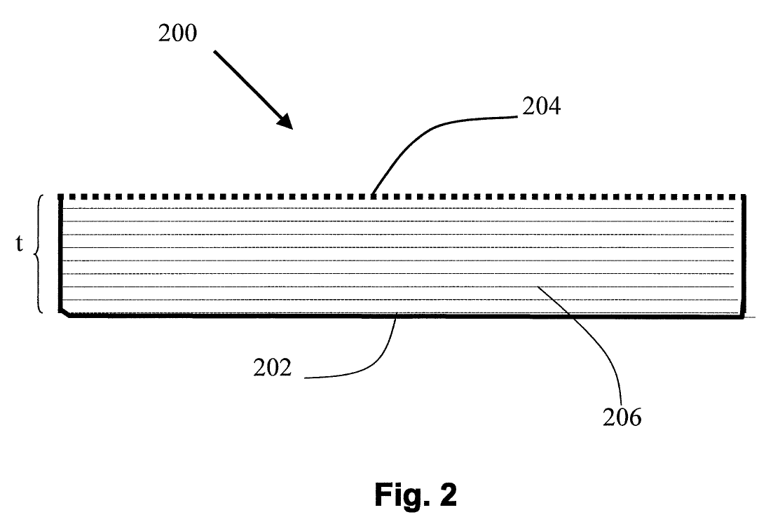

A cross-sectional view of a pet bed is illustrated in FIG. 2. The pet bed 200 includes an outer cover having a bottom surface 202 and a top surface 204. The top surface 204 comprises a material that is softer than the bottom surface 202 and is comfortable for the dog to lie upon. The outer cover encloses a fiber batt 206 that has been sized to fit snugly within the outer cover, and that has a uniform thickness (t) throughout substantially the entire cross-section of the fiber batt, and hence the entire cross-section of the pet bed. When the fiber batt 206 is placed within the outer cover in this manner, the individual fiber webs comprising the fiber batt lie in substantially parallel relation to the bottom surface 102 and top surface 204 of the pet bed 200.

Synthetic fibers, such as of polyester fibers can advantageously be used to form the fiber batt and improve the properties of the dog bed. In one embodiment, the fiber batt consists essentially of synthetic fibers. The synthetic fibers preferably have relatively high linear density, as measured in deniers. A denier is a unit of measure for the linear mass density of fibers and is defined as the mass in grams per 9,000 meters of fiber. As an example, a 1 denier polyester fiber has a diameter of about 10 micrometers. Preferably, the synthetic fibers have a linear density of at least about 8 denier, more preferably at least about 10 denier, even more preferably at least about 12 denier and even more preferably at least about 14 denier. According to one preferred embodiment, the polyester fiber has a linear density of about 15 denier.

It has also been found that the fibers should have a relatively long length to provide adequate support for larger pet animals such as dogs. Accordingly, in one embodiment, synthetic fibers preferably have an average length of at least about 2 inches and more preferably at least about 2.5 inches. According to one particular embodiment, the synthetic fibers have an average length of from about 2 inches to about 3 inches. These fiber lengths are longer than those that are typically used to form fiber batts, and have been found to provide better support for larger pet animals, such as dogs.

Further, it has also been found to be advantageous to use more than one type of fiber in the fiber batt that forms the filler material for the pet bed. Preferably, the fibers in the fiber batt are a blend of at least 2 different types of fibers. In one embodiment, a blend of conjugate fibers and crimped staple fibers is utilized. Conjugate fibers are spirally crimped fibers that are very durable and resilient. The conjugate fibers advantageously provide good loft and support for the bed, while the crimped staple fibers help cross-link the conjugate fibers in the garnetting process. Preferably, at least about 50% of the fibers in the fiber batt are conjugate fibers and more preferably at least about 60% of the fibers in the fiber batt are conjugate fibers. It is also preferred that the fiber batt include not greater than about 80% conjugate fibers, such as not greater than about 70% conjugate fibers. Further, the fiber batt preferably includes at least about 20% crimped staple fibers and more preferably at least about 30% crimped staple fibers, and not greater than about 50% crimped staple fibers, such as not greater than about 40% crimped staple fibers. According to one particular embodiment, the fiber batt includes from about 60% to about 70% conjugate fibers and from about 30% to about 40% crimped staple fibers. According to one embodiment, the fiber batt comprises about 66% conjugate fibers and about 34% crimped staple fibers.

In constructing the pet bed, the fiber batt can be placed in a fiber batt cover, such as a cover made from a non-woven material. Preferably, the fiber batt cover is made from a material such as spun bond polyethylene. The fiber batt is preferably permanently enclosed in the fiber batt cover, such as by sewing the fiber batt cover shut after placement of the fiber batt. This is preferred, as opposed to closing the fiber batt cover using a zipper or other temporary means (as with the outer cover), to prevent the removal of the fiber batting from the bed, such as by small children.

The enclosed fiber batt can then be placed into an outer cover, as is described above, which defines a volume for containing the covered fiber batt. In this way, the fiber batt can be easily removed from within the outer cover (e.g., by unzipping the outer cover) to permit the outer cover to be periodically cleaned.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A pet bed, the pet bed comprising:
an outer cover having a top surface and a bottom surface; and
a fiber batt disposed within said outer cover, wherein said fiber batt is formed by cross-lapping a garnetted web of fibers.

2. The pet bed of claim 1, wherein said fibers comprise synthetic fibers.

3. The pet bed of claim 2, wherein said synthetic fibers comprise polyester fibers.

4. The pet bed of claim 2, wherein said synthetic fibers comprise crimped fibers and conjugate fibers.

5. The pet bed of claim 4, wherein said synthetic fibers comprise at least about 50% conjugate fibers.

6. The pet bed of claim 2, wherein said synthetic fibers have a linear density of at least about 10 denier.

7. The pet bed of claim 2, wherein said synthetic fibers have an average length of at least about 2 inches.

8. The pet bed of claim 1, wherein said fiber batt has a thickness in its natural state of at least about 3 inches throughout substantially the entire cross-section of said fiber batt.

9. The pet bed of claim 2, wherein said fiber batt is enclosed within a non-woven fiber batt cover.

10. The pet bed of claim 2, wherein said synthetic fibers have a linear density of at least about 12 denier and said fiber batt has a thickness in its natural state of at least about 4 inches throughout substantially the entire cross-section of said fiber batt.

11. A pet bed, the pet bed comprising:
an outer cover having a top surface and a bottom surface; and
a fiber batt disposed within said outer cover, wherein said fiber batt is formed by cross-lapping a garnetted web of synthetic fibers having linear density of at least about 10 denier and having an average length of at least about 2 inches.

12. The pet bed of claim 11 wherein said fiber batt has a thickness in its natural state of at least about 4 inches throughout substantially the entire cross-section of said fiber batt.

13. The pet bed of claim 11, wherein said fibers comprise a blend of conjugate fibers and crimped staple fibers.

14. The pet bed of claim 11, wherein said synthetic fibers comprise polyester fibers.

15. The pet bed of claim 11, wherein said top surface of said outer cover comprises a material that is different than the material comprising said bottom surface.

16. The pet bed of claim 11, wherein said synthetic fibers have a linear density of at least about 12 denier.

17. A method for the manufacture of a pet bed, comprising the steps of:
providing a garnetted fiber web comprising synthetic fibers;
cross-lapping the fiber web to form a fiber batt, the fiber batt having a thickness of at least about 3 inches in its natural state;
trimming the fiber batt to a pre-determined size;
placing the fiber batt within an outer cover to form a pet bed.

18. A method as recited in claim 17, wherein said synthetic fibers comprise polyester fibers.

19. A method as recited in claim 17, wherein said synthetic fibers have a linear density of at least about 12 denier.

20. A method as recited in claim 17, wherein said synthetic fibers have an average length of at least about 2 inches.
